(19) United States
(12) Patent Application Publication
(10) Pub. No.: US 2010/0140825 A1
(43) Pub. Date: Jun. 10, 2010

(54) MANUFACTURING METHOD OF THREE-DIMENSIONAL CROSS-LINKED FOAM FOR UPPRS OF SHOES

(76) Inventor: Jang Won Park, Busan (KR)

Correspondence Address: BIRCH STEWART KOLASCH & BIRCH, PO BOX 747, FALLS CHURCH, VA, 22040-0747, US

(21) Appl. No.: 11/815,638

(22) PCT Filed: Apr. 28, 2005
(86) PCT No.: PCT/KR2005/001227

§ 371 Date: Aug. 6, 2007

(30) Foreign Application Priority Data
Feb. 7, 2005 (KR) 10-2005-0011116

(51) Int. Cl. B29C 49/00

(52) U.S. Cl. 264/46.4

(57) ABSTRACT

The present invention provides a manufacturing method of three-dimensional cross-linked foam for uppers of shoes that comprises preparing plural foaming materials having a planar shape with the cross-linked foaming suppressed; forming at least one interfacing pattern including a main interfacing pattern on at least one of the foaming materials; cross-linked foaming the foaming material to obtain a planar cross-linked foam having at least one inner cavity structure including a main inner cavity structure, the main inner cavity structure formed by the main interfacing pattern; disposing the planar cross-linked foam in a cavity of a molding die, the cavity having a shape corresponding to a last; and blow molding a covering portion of the main inner cavity structure into a shape corresponding to the cavity of the molding die by closing the molding die and injecting fluid into the main inner cavity structure.

### TECHNICAL FIELD

The present invention relates to a cross-linked foam, and more specifically a manufacturing method of three-dimensional cross-linked foam for uppers of shoes by which a feeling of unity, a fitting feeling and a shock absorbing property of the uppers can be greatly improved.

### BACKGROUND ART

A last is one of basic tools for manufacturing various components of shoes such as soles and uppers. The last is usually formed according to the shape of the feet using a hard material such as metal. Because the feet has curved surfaces at many portions such as a sole, an instep and an ankle, the last is shaped after the feet having the curved surfaces.

The general manufacturing process of the uppers is as follows according to the related art. Firstly, a three-dimensional shape of the surface of the last must be transformed into two-dimensional numerical values and a planar last pattern (or master pattern) for the uppers is obtained using the transformed numerical values. Secondly, various components of the uppers are designed within a range of the planar last pattern. Thirdly, the designed components are cut and then sewed to each other. Fourthly, the last is put into the sewed upper having a certain shape and then the sewed upper is finally molded into a complete upper having a three-dimensional shape corresponding to the last by attaching additional components to the sewed upper and heating the upper.

However, because the aforementioned related art utilizes planar source materials such as leather and textile to obtain a three-dimensional upper for shoes while the last has a three-dimensional shape, the related art has following disadvantages. Unlike polyhedrons of which planar surfaces form a certain angle among them and form a three-dimensional structure, each portions of the last has curved surfaces. Accordingly, if the three-dimensional shape of the last is transformed into the planar shape of the source material for the upper, a lot of areas of the source material is overlapped and a degree of the overlapped area is not uniform owing to a different curvature at each overlapped portion. But information and data on the geometric difference of the curvature of the last is not exactly applied to the last patterning process widely used in the filed. As long as the exact information on the geometric difference of the curvature of the last is not included in the last patterning process, the complete upper obtained by this method fails to be formed faithfully after the outer surface of the last.

To overcome this problem, exact information on the curvature of the last is analyzed and then the analyzed information is applied to a design of the upper by computerized devices. However, there still exist a lot of presumptions and estimations involved in the last patterning process and a design process of components.

Meanwhile, the components constituting the sewed upper are usually formed of planar material such as leather, textile, nonwoven fabric and shock-absorbing sponge. The three-dimensional sewed upper is obtained by cutting and sewing these planar materials and then the last is put into the sewed upper to mold the sewed upper into a complete upper. However the curved shape of the obtained complete upper is not so natural as the last.

Various methods have been tried to form the sewed upper in a more perfect shape corresponding to the last. That is, the sewed upper may be molded for a longer time with the last put therein or an injection molded material having a certain curved shape may be put into or attached to the sewed upper. Or exterior material such as a paper ball may be put into the upper to keep the three-dimensional shape of the upper until a user puts on the shoes.

However, those methods of long time molding and insertion of the injection-molded material decrease a manufacturing efficiency so that they are not proper for a mass production. The method using the paper ball cannot guarantee efficiency in keeping the shape of the upper. Therefore, more fundamental and epoch-making development has been requested to overcome the aforementioned problems at a time.

### DISCLOSURE OF INVENTION

### Technical Problem

Accordingly, the present invention has been made keeping in mind the above problems occurring in the related art, and an object of the present invention is to provide a manufacturing method of a three-dimensional cross-linked foam for uppers of shoes by which an upper can be formed to have a naturally curved shape corresponding to the last.

Another object of the present invention is to provide a manufacturing method of three-dimensional cross-linked foam for uppers of shoes by which three-dimensional uppers of shoes can be formed in a shape corresponding to the last without an additional process.

Another object of the present invention is to provide a manufacturing method of three-dimensional cross-linked foam for uppers of shoes that can make the upper to have a different physical property for each portion and give a function of air ventilation to the upper.

### Technical Solution

To achieve these and other advantages and in accordance with the purpose of the present invention, as embodied and broadly described, a manufacturing method of three-dimensional cross-linked foam for uppers of shoes comprises preparing plural foaming materials having a planar shape with the cross-linked foaming suppressed; forming at least one interfacing pattern including a main interfacing pattern on at least one of the foaming materials to prevent physical and chemical combination between the foaming materials, the interfacing pattern formed of at least one interfacing material; cross-linked foaming the foaming material to obtain a planar cross-linked foam having at least one inner cavity structure including a main inner cavity structure, the main inner cavity structure formed by the main interfacing pattern; disposing the planar cross-linked foam in a cavity of a molding die, the cavity having a shape corresponding to a last; and blow molding a covering portion of the main inner cavity structure into a shape corresponding to the cavity of the molding die by closing the molding die and injecting fluid into the main inner cavity structure.

In the above the number of the foaming materials may be two and the main interfacing pattern may be formed on one or all of opposing surfaces of two foaming materials.

In the above, the number of the foaming materials may be three or more selected among odd numbers and the main interfacing pattern may be formed on one or all of opposing surfaces of a selected pair of neighboring foaming materials.

In the above, the number of the foaming materials may be four or more selected among even numbers and the main interfacing pattern may be formed on one or all of opposing surfaces of a selected pair of neighboring foaming materials.

In the above, at least one subsidiary interfacing pattern may be formed on at least one of opposing surfaces of the foaming materials except the opposing surfaces of the foaming materials on which the main interfacing pattern is formed. The subsidiary interfacing pattern forms a subsidiary inner cavity structure in the cross-linked foam.

In the above, the number of the subsidiary interfacing patterns may be plural.

In the above, at least one of the subsidiary interfacing patterns may be connected to another subsidiary interfacing pattern.

In the above, the main interfacing pattern may have a shape corresponding to a vertical section of a last.

In the above, unevenness may be formed on a surface of the cavity of the molding die.

In the above, the unevenness may correspond to a shape of a subsidiary inner cavity structure formed by the subsidiary interfacing pattern.

In the above, the fluid may be at least one of gas, same material as or different material from the cross-linked foam.

In the above, the method may further comprise filling at least one of the subsidiary inner cavity structures with at least one of gas, liquid, same material as or different material from the cross-linked foam after one of the cross-linked foaming, the disposing and the blow molding.

In the above, at least one of the subsidiary inner cavity structures may be filled with an injection-molded material having a certain shape.

In the above, the method may further comprise forming at least one air passage connected to at least one of the subsidiary inner cavity structures in the cross-linked foam after one of the cross-linked foaming, the disposing and the blow molding.

In the above, at least one air passage connected to the main inner cavity structure may be formed in the cross-linked foam.

In the above, the foaming material may be a thin film type foaming material having a uniform thickness.

In the above, the thin film type foaming material may be formed by processing foaming materials having various shapes such as pellets and a sheet.

It is to be understood that both the foregoing general description and the following detailed description are exemplary and explanatory and are intended to provide further explanation of the invention as claimed.

### Advantageous Effects

According to the present invention, unlike the related art in which a three-dimensional shape of the last is transformed into planar shape information and then a three-dimensional upper is realized using the planar shape information, foaming materials are foamed into planar cross-linked foam and then the planar cross-linked foam is molded into a three dimensional cross-linked foam having a shape corresponding to a last so that a curved surface of the last can be faithfully embodied in the upper.

Because a fundamental attribute of the cross-liked foam for uppers is three-dimensional according to the present invention, a shape of the upper can be kept firm without distortion after a long time use of the shoes.

Because the three-dimensional cross-linked foam for uppers of shoes can have a different physical property at each portion according to the present invention, an appearance, a supporting power, a stability, a fitting feeling and a shock-absorbing property of the upper can be greatly improved.

In addition, the three-dimensional cross-linked foam for uppers of shoes can guarantee stabilities of dimension and shape of the upper and also can have an air ventilation function to circulate air between the inside and the outside of the upper. Accordingly, the user can have a fresh feeling even after a long time use of the shoes.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a flow chart illustrating a manufacturing process of a cross-linked foam for uppers of shoes according to the present invention;

FIGS. 2 to 6 are illustrating an exemplary manufacturing sequence of the cross-linked foam for uppers of shoes according to an embodiment of the present invention;

FIG. 7 is a cross-sectional view taken along B-B′ of FIG. 6;

FIG. 8 is illustrating a complete uppers obtained by processing the cross-linked foam for uppers of shoes manufactured according to the present invention;

FIG. 9 is illustrating a manufacturing process of the cross-linked foam for uppers of shoes according to another embodiment of the present invention;

FIG. 10 is a cross-sectional view taken along C-C′ of FIG. 9;

FIG. 11 is illustrating a manufacturing process of the cross-linked foam for uppers of shoes according to another embodiment of the present invention; and

FIG. 12 is a cross-sectional view taken along D-D′ of FIG. 11.

### MODE FOR THE INVENTION

Reference will now be made in detail to the preferred embodiment of the present invention, which is illustrated in the accompanying drawings. A planar shape means that an overall shape is planar even though there exists a partially projected portion and a three-dimensional shape means the same shape as or similar shape to a last having curved surfaces.

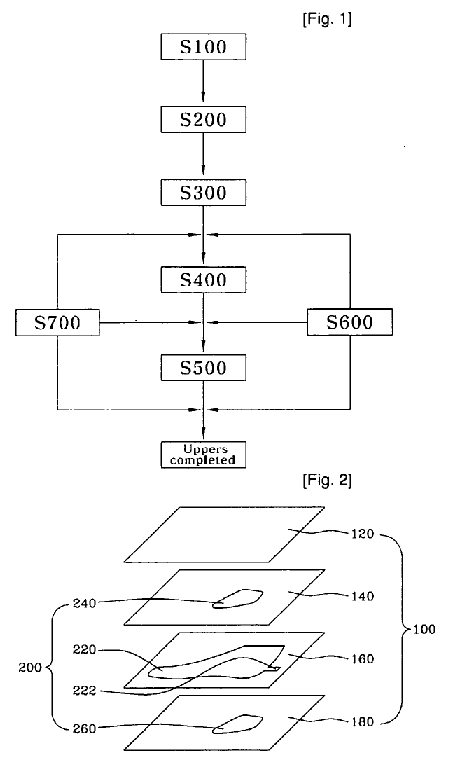

FIG. 1 is a flow chart illustrating a manufacturing process of a cross-linked foam for uppers of shoes according to the present invention. As shown in FIG. 1, the manufacturing method of the present invention mainly comprises a step of preparing foaming material (S100), a step of forming an interfacing pattern (S200), a step of cross-liked foaming (S300), a step of disposing (S400) and a step of blow molding (S500).

In the step S100, a source material for the foaming material is selected from various materials considering a use and a physical property of the desired cross-linked foam. After planning the material composition, the source material and sub materials are weighed by desired amounts in accordance with the material composition plan, and then the source material and the sub materials are mixed in the properly selected mixing device. The mixed chemical compound is then processed in a foaming material with a cross-linked foaming suppressed by a calender or an extruder.

The foaming material is not limited to a certain material as long as it can be formed into foam by any of widely known cross-linked foaming methods. However, it is recommended to adopt EVA (ethylene-vinyl acetate) that can contain a variable percentage of an amount of vinyl acetate (VA %) or the polyethylene (PE) based synthetic resin having various densities as the source material.

The foaming material according to the present invention is not limited to a specific shape or type. But the foaming material must be weighed at every foaming process if a foaming material of a particle or sheet type is used. Accordingly, the foaming material is highly recommended to have a plane shape, particularly a thin film shape, which has a low surface roughness considering its efficient application to embodiments of the present invention. If the prepared foaming material has a shape such as the pellet or the sheet having a rough surface, it may desirably be re-processed into a thin film having a low surface roughness. However, the shape of the foaming material is not limited as long as it can be processed into a certain shape with the cross-linked foaming suppressed and an interfacing pattern can be formed thereon later in the process.

The necessary number of the foaming materials for the present invention is not limited however it must be at least two or more considering an interfacing pattern forming process that will be described later.

In the step S200, at least one interfacing pattern is formed on the foaming material using different material from the foaming material to prevent a physical and chemical interaction among particles of the foaming materials. The interfacing pattern forms an inner cavity structure in the cross-linked foam during a cross-linked foaming process that will be described later.

The material for the interfacing pattern may be liquid having viscosity, powder or solid having a certain shape such as films as long as it is able to prevent the interaction between the foaming materials during the cross-linked foaming process. For example, the interfacing material may be selected from a group consisting of natural or synthetic paints or inks, natural or synthetic resins, papers, textiles, non-woven fabrics, and rubbery materials. The interfacing material can be selected considering various properties such as an easy adhesion to the foaming material, an easiness of repeated execution on a specific area of the foaming material, a possibility of obstructing the cubical expansion of the foaming material during the foaming process and an easiness of elimination from the cross-linked foam if necessary after the foaming process.

The formation of the interfacing pattern may be achieved by printing, transcription, coating, deposition, lamination, spray, cloth attachment, inserting, attaching or a modification thereof, and any other method can be selected only if it is able to form the interfacing pattern on the surface of the foaming material. However, when the ink or the like containing various kinds of resins dissolved is used as an interfacing material, the printing method is desirably adopted for forming the interfacing pattern.

The interfacing patterns may comprise a main interfacing pattern and a subsidiary interfacing pattern. The main interfacing pattern may be formed on one of opposing surfaces of neighboring foaming materials or on both opposing surfaces of neighboring foaming materials. More specifically, if two foaming materials are prepared, the main interfacing pattern may be formed either on one of opposing surfaces of the two foaming materials or on both opposing surfaces of the two foaming materials. If three foaming materials defined as a, b and c, respectively, are prepared in a sequence of a, b and c, one of pairs of the foaming materials (a, b) and (b, c) may be selected and then the main interfacing pattern may be formed on one of opposing surfaces of the selected pair of the foaming materials or on both opposing surfaces of the selected pair of the foaming materials. If four foaming materials defined as a, b, c and d, respectively, are prepared in a sequence of a, b, c and d, one of pairs of the foaming materials (a, b), (b, c) and (c, d) may be selected and then the main interfacing pattern may be formed on one of opposing surfaces of the selected pair of the foaming materials or on both opposing surfaces of the selected pair of the foaming materials.

A shape of the main interfacing pattern is not limited however the main interfacing pattern may desirably have a shape corresponding to a vertical section of a last considering a blow molding process that will be described later. The main interfacing pattern forms a main inner cavity structure in the cross-linked foam during a cross-linked foaming step and the main inner cavity structure is expanded to a surface of a cavity of a blow molding die during a blow molding step that will be described later. Accordingly, a total area of the main interfacing pattern may desirably be a little bit larger than that of the cavity of the blow molding die.

The subsidiary interfacing pattern may desirably be formed on one of opposing surfaces of neighboring foaming materials or on all opposing surfaces of neighboring foaming materials except the opposing surfaces of the foaming materials on which the main interfacing pattern is to be formed. It is desirable to form the subsidiary interfacing pattern on the foaming material when three or more foaming materials are used for the present invention. More specifically, if three foaming materials defined as a, b and c, respectively, are prepared in a sequence of a, b and c and the main interfacing pattern is formed on one or all of opposing surfaces of a pair (a, b), it is desirable to form the subsidiary interfacing pattern on one or all of opposing surfaces of a pair (b, c). If four foaming materials defined as a, b, c and d, respectively, are prepared in a sequence of a, b, c and d and the main interfacing pattern is formed on one or all of opposing surfaces of a pair (a, b), it is desirable to form the subsidiary interfacing pattern on one or all of opposing surfaces of a selected pair from (b, c) and (c, d) or all pairs (b, c) and (c, d). The same rule can be applied to other cases when the main interfacing pattern is formed on opposing surfaces of a pair (b, c) or (c, d). That is, if the main interfacing pattern is formed on the opposing surfaces of the pair (b, c), the subsidiary interfacing pattern may be formed on the opposing surfaces of one of the pairs (a, b) and (c, d) or all of the pairs (a, b) and (c, d). If the main interfacing pattern is formed on the opposing surfaces of the pair (c, d), the subsidiary interfacing pattern may be formed on the opposing surfaces of one of the pairs (a, b) and (b, c) or all of the pairs (a, b) and (b, c).

The main and subsidiary interfacing patterns may be formed of same or different material. The foaming agent that is same as or different from the foaming agent included in the foaming material may be included in materials for the interfacing pattern. The number of the subsidiary interfacing patterns may be plural and each of the subsidiary interfacing patterns may have a same or different shape. When plural subsidiary interfacing patterns are formed on the foaming materials, the plural subsidiary interfacing patterns may not be connected to each other or all or some of the plural subsidiary interfacing patterns may be connected to each other. Or the plural subsidiary interfacing patterns may form plural groups of the subsidiary interfacing patterns in which neighboring subsidiary interfacing patterns are connected to each other.

As shown in FIG. 2, four thin film type foaming materials 120, 140, 160 and 180 are prepared and the main interfacing pattern 220 and the subsidiary interfacing patterns 240 and 260 are formed on selected foaming materials 160, 140 and 180. The main interfacing pattern 220 having a shape corresponding to a vertical section of a last (not shown) is formed on the foaming material 160 and subsidiary interfacing patterns 240 and 260 having any shape are formed on the foaming materials 140 and 180, respectively. The reference number 222 is an injection interfacing pattern and it will be described later. A forming position of the injection interfacing pattern may freely be altered considering a relation with an external injection device that will be described later.

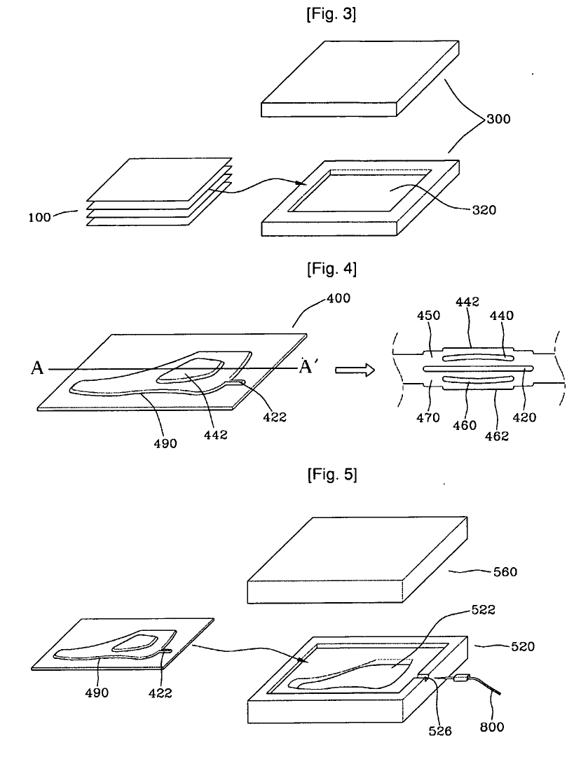

In the step S300, a planar cross-linked foam 400 of FIG. 4 is formed by cross-linked foaming the foaming materials having the interfacing patterns thereon. The cross-linked foaming of the foaming material may be performed by one of a pressure cross-linked foaming method and normal pressure cross-linked foaming method but the cross-linked foaming method is not confined to those. In FIG. 3, a press type method using a molding die 300 is selected as one of the pressure cross-linked foaming methods.

If the heat is applied to the foaming material or if the electron rays are irradiated on the foaming material during the cross-linked foaming process, the foaming material is cross-linked in a gel state by the heat infliction or the electron irradiation. However, the foaming materials neighboring each other across the interfacing pattern are not physically or chemically coupled and interconnected until they reach the step of foaming. If foaming process is performed at this state, the foaming materials cubically expand at a specific rate and then the planar cross-linked foam 400 is made.

Portions of the foaming materials corresponding to the interfacing patterns 220, 240 and 260 also cubically expand at the similar ratio to the other portions during the foaming process. However, because the physical and chemical combination of the foaming material is prevented by the interfacing patterns 220, 240 and 260 and the interfacing patterns expand at the different ratio from the foaming material, empty spaces, i.e. inner cavity structures are formed in the cross-linked foam 400 at positions corresponding to the interfacing patterns 220, 240 and 260.

In FIG. 4, a drawing on the left is the planar cross-linked foam 400 and a drawing on the right is a sectional view of the planar cross-linked foam 400 taken along A-A′. As shown in the drawing, the empty spaces formed in the cross-linked foam 400 are inner cavity structures. A main inner cavity structure 420 is formed by the main interfacing pattern 220 and subsidiary inner cavity structures 440 and 460 are formed by the subsidiary interfacing patterns 240 and 260, respectively.

Gases such as nitrogen (N₂) and carbon dioxide (CO₂) that is generated by a decomposition action of the foaming agent during the foaming process is trapped in the inner cavity structure 420, 440 and 460 and thus keep the interior of the inner cavity structure 420,440 and 460 at a certain pressure. The interior pressure of the gases in the inner cavity structure 420, 440 and 460 can be properly controlled by adding a foaming agent to the interfacing material before the cross-linked foaming process. The unexplained reference numbers 450 and 470 are covering portions of the main inner cavity structure 420 and the unexplained reference numbers 442 and 462 are covering portions of the subsidiary inner cavity structures 440 and 460, respectively. Lateral surfaces of the planar cross-linked foam 400 is not formed in a completely flat shape but is projected a little bit owing to the gas filling each of the inner cavity structures.

The shape and structure of the inner cavity structures 420, 440 and 460 can be modified diversely by controlling shapes of the interfacing patterns or changing interfacing materials regardless of shapes and kinds of the tools and devices such as the shape of a cavity 320 of the molding die 300 for the cross-linked foaming process.

In the step S400, the planar cross-linked foam 400 having inner cavity structures 420, 440 and 460 is disposed in a blow molding die. As shown in FIG. 5, it is desirable that the planar cross-linked foam 400 be disposed in a cavity 522 having a contour corresponding to a contour 490 of the main inner cavity structure under the state in which the contour 490 of the main inner cavity structure corresponds to the contour of the cavity 522. The cavity 522 of the blow molding die 520 and 560 desirably has a shape corresponding to the last so that the planar cross-linked foam 400 can be molded into a three-dimensional shape corresponding to the last. As shown in the drawing, the blow molding die comprises upper and lower dies 560 and 520. The shape of the cavity (not shown) of the upper die 560 may correspond to inner side of the last and the shape of the cavity 522 of the lower die 520 may correspond to outer side of the last. However, these shapes of the cavity of the upper and lower dies 560 and 520 are exemplary and not confined to those illustrated in FIG. 5. A constitution of the blow molding die and a shape of the cavity of the blow molding die can be changed variously under various circumstances.

Unevenness may desirably be formed on a surface of the cavity of the blow molding die at positions corresponding to the projected covering portions 442 and 462 of the subsidiary inner cavity structures 440 and 460. Though a shape of the unevenness of the cavity of the blow molding die may be a little different from the projected covering portions 442 and 462, it is more desirable that it have a same shape as the covering portions 442 and 462. Unevenness may further be formed on the cavity of the blow molding die at positions that may do not correspond to the subsidiary inner cavity structures 440 and 460 and this unevenness forms additional unevenness on the surface of the cross-linked foam other than the surfaces of the covering portions 442 and 462 of the subsidiary inner cavity structures 440 and 460.

In particular, it is more desirable that unevenness may further be formed on the cross-linked foam 400 at a position corresponding to an instep of fore-foot to which a repeated bending stress is applied and a heel portion that should protect the feet from an external impact.

In the step S500, the blowing molding die is closed and the disposed planar cross-linked foam 400 is formed according to the shape of the cavity of the blow molding die. As shown in FIG. 5, fluid is injected into the main inner cavity structure 420 of the disposed cross-linked foam 400 via an injection port 526 formed on an edge portion of the blow molding die. This process is a so-called blow molding. An end of an injection device 800 is connected to an injection inner cavity structure 422 of the disposed planar cross-linked foam 400 through the injection port 526 of the blow molding die 520 and 560. The injection inner cavity structure 422 is connected to the main inner cavity structure 420. Once fluid is injected into the main inner cavity structure 420 via the injection port 526 at a certain pressure, the covering portions 450 and 470 of the main inner cavity structure 420 are put into a close contact with the surface of the cavity of the blow molding die by a fluid pressure. Accordingly, the planar covering portions 450 and 470 are formed in a shape corresponding to the cavity of the blow molding die by the fluid pressure. Though the injection inner cavity structure 422 is formed at a position corresponding to a heel portion of rear-foot of the last in the drawings, the injection inner cavity structure 422 can be formed at any position including fore-foot and middle-foot under various circumstances. The fluid that is injected into the main inner cavity structure 420 is desirably an air however the available fluid is not confined to the air. That is, the fluid can be selected from various gases, the same material as or different material from the cross-linked foam 400.

Meanwhile, the injection inner cavity structure 422 must be open before the injection of the fluid into the main inner cavity structure 420. That is, a portion of the injection inner cavity structure 422 must be connected to the outside by cutting a portion of the cross-linked foam 400 or making a hole on an outer side of the cross-linked foam 400 to let the fluid pass through it. This process must be performed before the blow molding step.

A softening process may be performed to the planar cross-linked foam by a heating means such as a heater before disposing the cross-linked foam in the blow molding die, which will facilitate the forming process in the blow molding die.

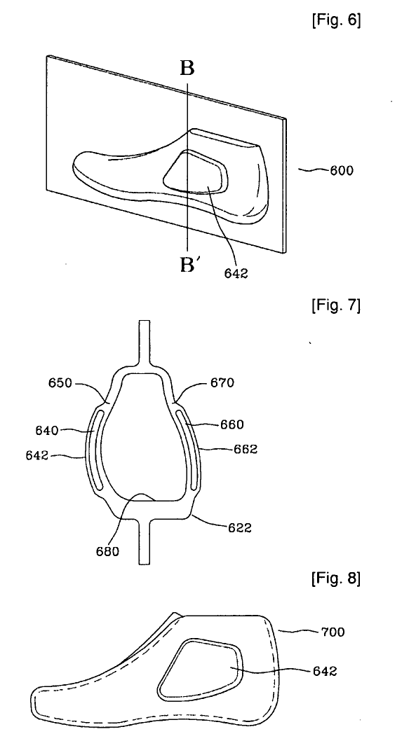

Once the blow molding step is finished and the blow molding die is open, a foamed upper 600 is obtained as shown in FIG. 6. FIG. 7 is a sectional view of the foamed upper 600 taken along B-B′ of FIG. 6. The covering portions 450 and 470 of the main inner cavity structure 420 of the planar cross-linked foam 400 is formed according to the shape of the cavity of the blow molding die by the fluid pressure as shown as reference numbers 650 and 670 in FIG. 7. An inner surface 680 of the foamed upper 600 has a naturally curved shape corresponding to the last so that a fitting feeling can be greatly improved.

The subsidiary inner cavity structures 640 and 660 formed respectively in the covering portions 450 and 470 are put into a close contact with the cavity of the blow molding die during the blow molding step so that they are naturally curved along a curved surface 622 of the foamed upper 600.

The subsidiary inner cavity structures 640 and 660 provide a solid feeling to the surface 622 of the foamed upper 600 in appearance and a shock-absorbing property to the foamed upper 600 in function. That is, because the subsidiary inner cavity structures 640 and 660 have the gas trapped therein at a certain pressure, supporting property, stability and fitting feeling of the foamed upper 600 is increased. In addition, the foamed upper 600 itself can protect the feet effectively owing to an existence of the subsidiary inner cavity structures 640 and 660.

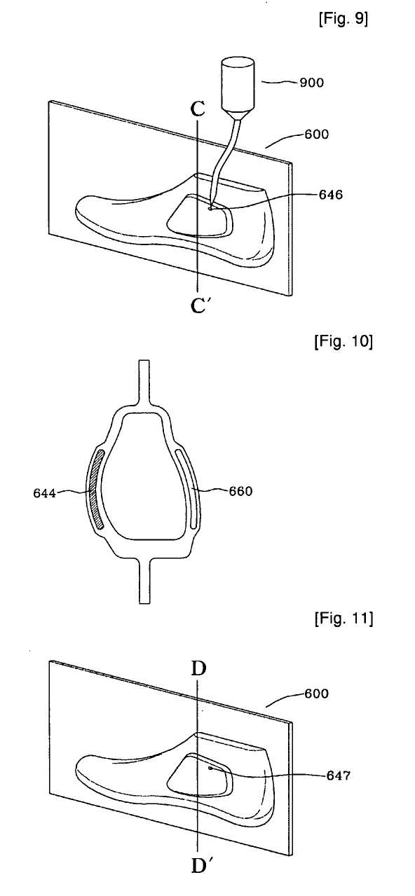

FIG. 8 is illustrating a complete upper 700 obtained by processing the three-dimensional foamed upper 600. Various additional patches and accessories such as textiles, leathers and injection molded materials may be further added to inner and outer surfaces of the complete upper 700 for functional or ornamental purposes. This additional process will not be described here in detail because it is well known in the filed.

Though the subsidiary inner cavity structures 640 and 660 itself has a shock-absorbing property owing to the gas such as nitrogen (N₂) and carbon dioxide (CO₂) generated during the foaming process, the shock-absorbing function of the subsidiary inner cavity structures 640 and 660 can be further improved by filling the subsidiary inner cavity structures 640 and 660 with a certain amount of gas after the step of cross-linked foaming (S300). That is, at least one of the subsidiary inner cavity structures 640 and 660 may be filled with filler by forming an injection hole on the subsidiary cavity structure after one of the step of cross-linked foaming, the step of disposing and the step of blow molding.

In the step of filling S600, the filler may be selected from gas, same material as or different material from the cross-linked foam and it may be polyurethane, for example. If there are plural subsidiary inner cavity structures, each of the subsidiary inner cavity structures may be filled with different fillers or only a certain subsidiary inner cavity structure may be filled with special filler. Accordingly, some of the plural subsidiary inner cavity structures may be filled with gas and other subsidiary inner cavity structures may be filled with non-gaseous filler such as polyurethane. Besides, all of the plural subsidiary inner cavity structures may be connected to each other and filled with same material or adjacent subsidiary inner cavity structures may be connected to each other and filled with same or different material. The filler may be selected from various materials in a phase of gas, liquid or solid and may be a molded material having a certain shape.

In FIG. 9, an injection hole 646 is formed on a subsidiary inner cavity structure positioned at an outer side of a foamed upper 600. The selected subsidiary inner cavity structure is filled with liquefied polyurethane using an external filling device 900 via the injection hole 646. FIG. 10 is sectional view of the foamed upper 600 taken along C-C′ of FIG. 9. Because the subsidiary inner cavity structures 640 and 660 are shaped naturally along the curved surface 622 of the foamed upper 600, the polyurethane 644 filling the subsidiary inner cavity structure also has a naturally curved shape after it is hardened. If at least one subsidiary inner cavity structures selected from subsidiary inner cavity structures are filled with other materials than gas, the fitting feeling between the shoes and the feet can be more improved and the feet can be more effectively protected from an external impact.

At least one air passage may be formed at one of the subsidiary inner cavity structures in a step S700. The air passage forming process may be performed any time after the step of cross-linked foaming (S300) in which the subsidiary inner cavity structures are formed. The air passage may be formed only at the covering portion of the subsidiary inner cavity structure to circulate air between the inside and the outside of the subsidiary inner cavity structure or it may further be formed at an inner surface of the upper to be connected to the subsidiary inner cavity structure. In the latter case, the air in the upper can circulate between the inside and the outside of the upper via the subsidiary inner cavity structure.

If there are plural subsidiary inner cavity structures and all or some of the plural subsidiary inner cavity structures are connected to each other, the air passage may be formed at all or at least one of the plural subsidiary inner cavity structures using the aforementioned methods.

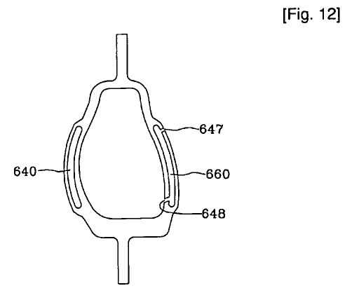

In FIG. 11, the air passage 647 is formed at the covering portion of the subsidiary inner cavity structure positioned at an inner side of the upper 600. FIG. 12 is a sectional view of the upper taken along D-D′ of FIG. 11. In FIG. 12, inner and outer air passages 648 and 647 are formed respectively on the inner surface of the upper 600 and the covering portion of the subsidiary inner cavity structure 660 positioned at the inner side of the upper 600.

Because the covering portion 642 and 662 is formed simultaneously with the cross-linked foam in a unity during the cross-linked foaming step S300, the dimension and shape stabilities can be guaranteed for a long time although the air passage 647 and 648 are formed on the upper. The position and number of the air passages can be changed depending on the condition and is not limited. In addition, a valve may be connected to the air passage to control an amount of the air flowing in and out of the air passages.

It will be apparent to those skilled in the art that various modifications and variations can be made in a manufacturing method of three-dimensional cross-linked foam for uppers of shoes without departing from the spirit or scope of the invention. Thus, it is intended that the present invention cover the modifications and variations of this invention provided they come within the scope of the appended claims and their equivalents.

1. A manufacturing method of three-dimensional cross-linked foam for uppers of shoes, comprising:
preparing plural foaming materials having a planar shape with the cross-linked foaming suppressed;
forming at least one interfacing pattern including a main interfacing pattern on at least one of the foaming materials to prevent physical and chemical combination between the foaming materials, the interfacing pattern formed of at least one interfacing material;
cross-linked foaming the foaming material to obtain a planar cross-linked foam having at least one inner cavity structure including a main inner cavity structure, the main inner cavity structure formed by the main interfacing pattern;
disposing the planar cross-linked foam in a cavity of a molding die, the cavity having a shape corresponding to a last; and
blow molding a covering portion of the main inner cavity structure into a shape corresponding to the cavity of the molding die by closing the molding die and injecting fluid into the main inner cavity structure.

2. The method according to claim 1, wherein the number of the foaming materials is two and the main interfacing pattern is formed on one or all of opposing surfaces of two foaming materials.

3. The method according to claim 1, wherein the number of the foaming materials is three or more selected among odd numbers and the main interfacing pattern is formed on one or all of opposing surfaces of a selected pair of neighboring foaming materials.

4. The method according to claim 1, wherein the number of the foaming materials is four or more selected among even numbers and the main interfacing pattern is formed on one or all of opposing surfaces of a selected pair of neighboring foaming materials.

5. The method according to one of claims 3 to 4, wherein at least one subsidiary interfacing pattern is formed on at least one of opposing surfaces of the foaming materials except the opposing surfaces of the foaming materials on which the main interfacing pattern is formed, the subsidiary interfacing pattern forming a subsidiary inner cavity structure in the cross-linked foam.

6. The method according to claim 5, wherein the number of the subsidiary interfacing patterns are plural.

7. The method according to claim 6, wherein at least one of the subsidiary interfacing patterns is connected to another subsidiary interfacing pattern.

8. The method according to any one of claims 1 to 4, wherein the main interfacing pattern has a shape corresponding to a vertical section of a last.

9. The method according to claim 5, wherein the main interfacing pattern has a shape corresponding to a vertical section of a last.

10. The method according to any one of claims 6 to 7, wherein the main interfacing pattern has a shape corresponding to a vertical section of a last.

11. The method according to any one of claims 1 to 4, wherein unevenness is formed on a surface of the cavity of the molding die.

12. The method according to claim 5, wherein unevenness is formed on a surface of the cavity of the molding die.

13. The method according to claim 12, wherein the unevenness corresponds to a shape of a subsidiary inner cavity structure formed by the subsidiary interfacing pattern.

14. The method according to any one of claims 1 to 4, wherein the fluid is at least one of gas, same material as or different material from the cross-linked foam.

15. The method according to claim 5, wherein the fluid is at least one of gas, same material as or different material from the cross-linked foam.

16. The method according to claim 5, further comprises filling at least one of the subsidiary inner cavity structures with at least one of gas, liquid, same material as or different material from the cross-linked foam after one of the cross-linked foaming, the disposing and the blow molding.

17. The method according to claim 16, wherein at least one of the subsidiary inner cavity structures is filled with an injection-molded material having a certain shape.

18. The method according to claim 5, further comprises forming at least one air passage connected to at least one of the subsidiary inner cavity structures in the cross-linked foam after one of the cross-linked foaming, the disposing and the blow molding.

19. The method according to claim 18, wherein at least one air passage connected to the main inner cavity structure is formed in the cross-linked foam.

20. The method according to any one of claims 1 to 4, wherein the foaming material is a thin film type foaming material having a uniform thickness.

21. The method according to claim 5, wherein the foaming material is a thin film type foaming material having a uniform thickness.

22. The method according to any one of claims 6, 7 and 9, wherein the foaming material is a thin film type foaming material having a uniform thickness.

23. The method according to claim 8, wherein the foaming material is a thin film type foaming material having a uniform thickness.

24. The method according to claim 10, wherein the foaming material is a thin film type foaming material having a uniform thickness.

25. The method according to claim 20, wherein the thin film type foaming material is formed by processing foaming materials having various shapes such as pellets and a sheet.

26. The method according to claim 22, wherein the thin film type foaming material is formed by processing foaming materials having various shapes such as pellets and a sheet.

27. The method according to any one of claims 21, 23 and 24, wherein the thin film type foaming material is formed by processing foaming materials having various shapes such as pellets and a sheet.
